(19) United States
(12) Patent Application Publication
(10) Pub. No.: US 2020/0068847 A1
(43) Pub. Date: Mar. 5, 2020

(54) Animal Care Facility Facilitating Sanitation

(71) Applicant: Wayne Covault, Los Angeles, CA (US)

(72) Inventor: Wayne Covault, Los Angeles, CA (US)

(21) Appl. No.: 16/559,456

(22) Filed: Sep. 3, 2019

Related U.S. Application Data
(60) Provisional application No. 62/727,317, filed on Sep. 5, 2018.

(51) Int. Cl. A01K 1/10; A01K 1/08; A01K 5/02; A01K 31/18; A01K 39/01

(52) U.S. Cl. CPC A01K 1/10; A01K 1/08; A01K 39/01; A01K 31/18; A01K 5/02

(57) ABSTRACT

A livestock enclosure enabling transfer of livestock from one compartment to a second compartment for purposes of cleaning one compartment is shown and described. The livestock enclosure has a feeder adjustable to make feed accessible to livestock in each one of the compartments at any one time, and gates or other closure for enabling livestock to migrate between the two compartments. Operating personnel can allow the adjustable feeder to be exhausted of feed and to open a gate to the other enclosure to encourage livestock to change compartments. The gate may be closed after the transfer to enable the operating personnel to clean the vacated compartment. The feeder can be adjusted or repositioned to serve either compartment. Optionally, both compartments may also have a non-adjustable principal feeder. Optionally, the livestock enclosure may include a roof and full height walls and motorized control of gates and the adjustable feeder.

### CROSS-REFERENCE TO RELATED APPLICATION

The present application claims priority to U.S. Provisional Application Ser. No. 62/727,317, filed Sep. 5, 2018, the contents of which is incorporated by this reference.

### FIELD OF THE INVENTION

The present invention relates to animal husbandry, and more particularly, to an animal enclosure adapted to facilitate transfer of livestock from one compartment to another, while facilitating feeding selectively in either compartment.

### BACKGROUND OF THE INVENTION

Livestock are typically kept in pens and like enclosures by farmers. While this is convenient for the farmer, confining livestock within limited enclosure requires periodic cleaning and other servicing of the enclosure. The livestock must usually be removed from the enclosure to enable orderly and efficient cleaning and servicing.

Moving the livestock therefore requires a supplementary space to be available. If the supplementary space is not provided with feed, sheltering, and possibly other amenities, it will become necessary to return the livestock to the original pen promptly. This imposes additional burdens on the farmer.

There exists a need to provide alternative space for accommodating livestock during servicing of one pen, while also providing the livestock with some or all of the amenities provided by the one pen.

### SUMMARY OF THE INVENTION

The present invention contemplates a livestock enclosure enabling transfer of livestock from one compartment to a second compartment for purposes of cleaning one compartment. The livestock enclosure has a feeder adjustable to make feed accessible to livestock in each one of the compartments at any one time, and gates or other closure for enabling livestock to migrate between the two compartments. Operating personnel can allow the adjustable feeder to be exhausted of feed and to open a gate to the other enclosure to encourage livestock to change compartments. The gate may be closed after the transfer to enable the operating personnel to clean the vacated compartment. The feeder can be repositioned to serve either compartment.

Optionally, both compartments may also have a non-adjustable principal feeder. Optionally, the livestock enclosure may include a roof and full height walls and motorized control of gates and the adjustable feeder.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a partial perspective view of a livestock enclosure according to the present disclosure;

FIG. 2 is a partial perspective view of FIG. 1, showing transfer of livestock from the livestock enclosure to another enclosure;

FIG. 3 is a floor plan of the full livestock enclosure of FIG. 1;

FIG. 4 is a partial floor plan of an alternative to the livestock enclosure of FIGS. 1-3;

FIG. 5 is a perspective view of the novel livestock enclosure as part of a building dedicated thereto;

FIG. 6 is a schematic view showing an optional motorized feature of the novel livestock enclosure; and

FIG. 7 is a schematic view showing a second optional motorized feature of the novel livestock enclosure.

### DETAILED DESCRIPTION

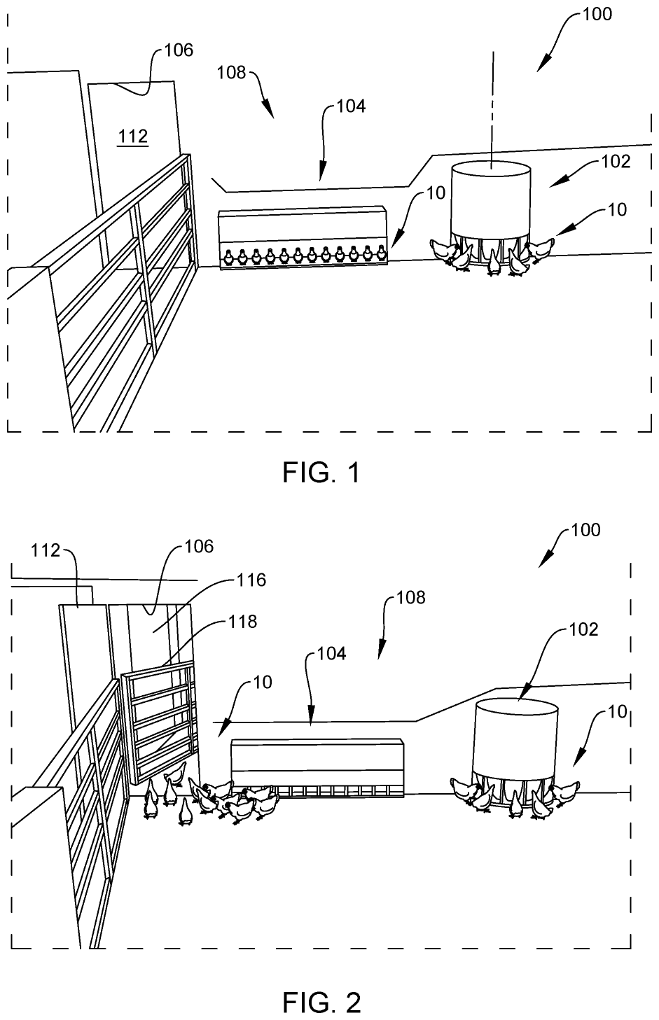

Referring first to FIG. 1, according to at least one aspect of the invention, there is shown a livestock enclosure 100 for housing livestock 10 (chickens are depicted) and selectively evacuating a portion of livestock enclosure 100 for maintenance thereto. In the embodiment of FIG. 1, livestock 10 are feeding at an adjustable feeder 102 and a supplementary feeder 104. Adjustable feeder 102 is adjustable in that it can be moved to serve livestock in another portion of livestock enclosure 100. That portion of livestock enclosure 100 occupied by livestock 10 in FIG. 1 may be termed a first housing area 108. Supplementary feeder 104 may be relied on as a primary feeder storing a larger quantity of feed (not shown) than adjustable feeder 102.

Adjustable feeder 102 comes into play when it is time to move livestock 10 into the other portion (not seen in FIG. 1) of livestock enclosure 100 to enable personnel to clean or otherwise service first housing area 108. Referring also to FIG. 2, when it is time to move livestock 10 into a new area, feed may be allowed to be depleted in supplementary feeder 104. Livestock 10 feeding at supplementary feeder 104 may then move to the other portion of livestock enclosure 100. The other portion will be termed second housing area 110 (not seen in FIGS. 1 and 2). Adjustable feeder 102 may be adjusted or moved to a new position serving second housing area 110.

Unless otherwise indicated, the terms “first”, “second”, etc., are used herein merely as labels, and are not intended to impose ordinal, positional, or hierarchical requirements on the items to which these terms refer. Moreover, reference to, e.g., a “second” item does not either require or preclude the existence of, e.g., a “first” or lower-numbered item, and/or, e.g., a “third” or higher-numbered item.

A portal 106 leads from first housing area 108 to second housing area 110. Portal 106 may be closed by a closure such as a first door 112. A first gate 114 is swung to reveal portal 106 to livestock 10. In the embodiment illustrated in FIGS. 1 and 2, second housing area 110 may include a second door 116 and a second gate 118 (both visible in FIG. 2).

The exact number, arrangement, and nature of first and second doors 112, 116 and first and second gates 114, 118 are not critical to the invention. It is merely desirable to isolate first and second housing areas 108, 110 from one another when livestock 10 are to occupy one of these, and to enable transit of livestock 10 when being transferred to the other one of first and second housing areas 108, 110 to facilitate servicing of the evacuated first or second housing area 108 or 110. Once livestock 10 have been removed from first or second housing area 108 or 110, servicing such as general cleaning, disinfecting, distribution of straw or other bedding, and the like may be performed.

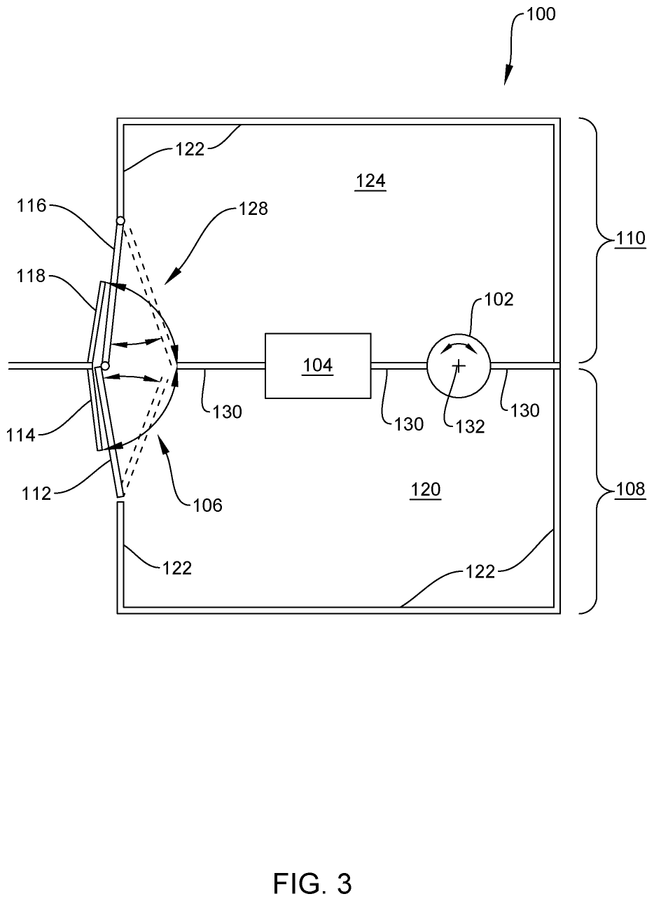

The basic concepts of apparatus and use of the invention have been described. As the apparatus of the invention may take a variety of forms and incorporate diverse features, these will be described. With particular reference to FIG. 3, there is shown livestock enclosure 100 for housing livestock 10 and selectively evacuating a portion of the livestock enclosure 100 for maintenance thereto. Livestock enclosure 100 may comprise first housing area 108 including a first floor surface 120, a first peripheral confinement barrier 122 surrounding first floor surface 120, and a first portal 106 enabling egress from first housing area 108 through first peripheral confinement barrier 122, and second housing area 110 including a second floor surface 124, a second peripheral confinement barrier 126 surrounding second floor surface 124, and a second portal 128 enabling egress from second housing area 110 through second peripheral confinement barrier 126.

Livestock enclosure 100 may further comprise adjustable feeder 102 selectively movable to a first deployed position (e.g., FIGS. 1 and 2) wherein feed (not shown) contained within adjustable feeder 102 is accessible to livestock 10 in first housing area 108 and to a second deployed position (e.g., with adjustable feeder 102 rotated one hundred eighty degrees from the first deployed position) wherein feed contained within adjustable feeder 102 is accessible to livestock 10 in second housing area 124.

First and second housing areas 108, 110 will be understood to be those areas occupied by livestock 10. Minimum structure defining first and second housing areas 108, 110 includes respectively, first and second floor surfaces 120, 124 and first and second peripheral confinement barriers 122, 126, and at least first portal 106 enabling egress from first housing area 108 through first and second peripheral confinement barrier 122, 126. As seen in FIG. 3, a portion 130 of first peripheral confinement barrier 122 is in common with a portion of second peripheral confinement barrier 126. This occurs when first and second housing areas 108, 110 abut one another. In this embodiment, adjustable feeder 102 is located in portion 130 of first peripheral confinement barrier 122 in common with the portion of second peripheral confinement barrier 126. First and second floor surfaces 120, 124 may be artificial or alternatively, may comprise natural ground. First and second peripheral confinement barriers may comprise as little as fencing, netting, and the like of sufficient sturdiness as to deter livestock 10 from leaving first and second floor surfaces 120, 124. Because their minimum purpose is to constrain livestock 10 against leaving first and second floor surfaces 120, 124, first and second peripheral confinement barriers may comprise deterrence arrangement such as those using energy in the form of light, sound, electrical impulses to generate a zone inhibiting loss of livestock 10 without the use of a solid physical barrier. Combinations of these options may also be employed.

First and second portals 106 and 128 may be integrated. That is, a single portal may be provided where first and second housing areas 108, 110 abut at a common peripheral confinement barrier 122, seen as portion 130 in FIG. 3. In summary, first portal 106 and second portal 128 are unitary, and include a closure (first and second doors 112, 116, and first and second gates 114, 118, collectively) selectively opening and closing first portal 106 and second portal 128.

As seen in FIG. 3, supplementary feeder 104 may be located in portion 130 of first peripheral confinement barrier 122 in common with the portion of the second peripheral confinement barrier such that feed contained within supplementary feeder 104 is accessible to livestock 10 in at least one of first housing area 108 and second housing area 110.

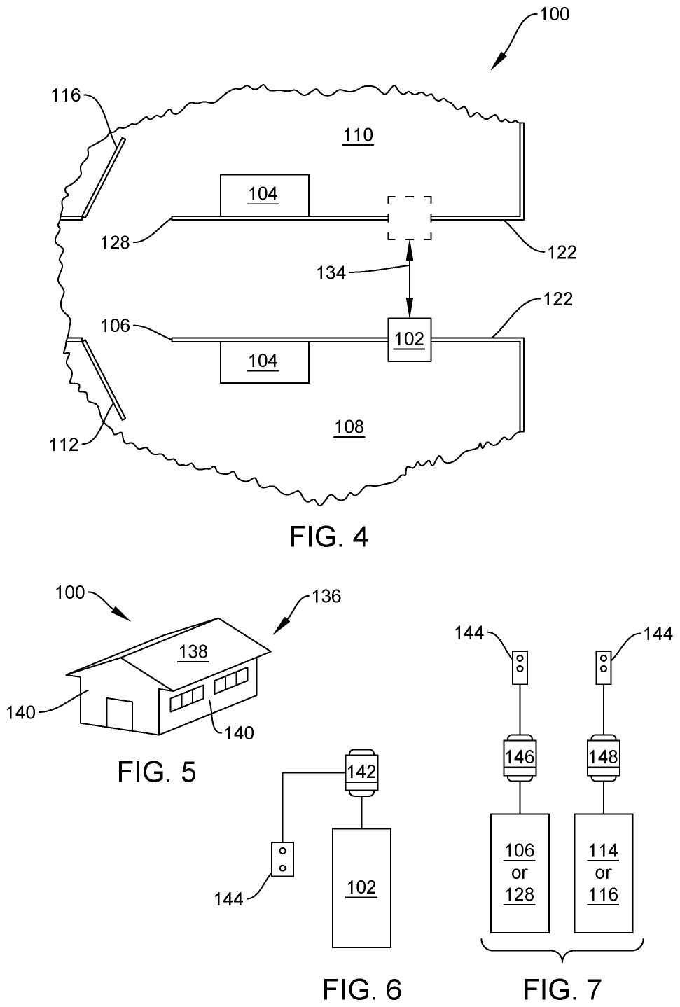

In an alternative embodiment shown in FIG. 4, first and second housing areas 108, 110 may be spaced apart from each other. In the embodiment of FIG. 4, first peripheral confinement barrier 122 is provided in separate sections, one for each of first and second housing areas 108, 110. In this embodiment, adjustable feeder 102 shuttles between the first deployed position (shown in solid lines) and the second deployed position (shown in broken lines), as indicated by arrow 134. Optional supplementary feeders 104 may be provided in both of first and second housing areas 108, 110, in only one of these, or omitted altogether. First and second portals 106, 128 are separate and spaced apart, although first and second housing areas 108, 110 could be extended to abut if desired. First and second doors 112, 116 and first and second gates 114, 118 (not shown in FIG. 4) may be arranged and supplemented as necessary to constrain livestock to move between first and second housing areas 108, 110. It is not necessary to provide both doors and gates, where the aforementioned constraint is achieved.

In summary, in the embodiment of FIG. 4, first portal 106 is separate from and communicates with second portal 128. Livestock enclosure 100 further comprises a closure (first and second doors 112, 116, and first and second gates 114, 118, collectively) selectively opening and closing first portal 106 to second portal 128.

Adjustment of adjustable feeder 102 refers to orientation in terms of exposing feed for access to livestock 10, and also to location. In the embodiment of FIGS. 1-3, adjustable feeder 102 is rotatable about a vertical axis of rotation 132 to face either first floor surface 120 or second floor surface 124. In the example of FIG. 4, adjustable feeder 102 shuttles by sliding on a track, rolling, etc. between the first and second deployed positions.

In an embodiment, livestock enclosure 100 may be more extensive than described with respect to first and second peripheral confinement barriers 122, 126. Notably, livestock enclosure 100 may comprise part of a building such as a barn (not shown), or may be part of a building 136 unto itself. As seen in FIG. 5, livestock enclosure 100 may comprise a roof 138 above first housing area 108 and second housing area 110 (see FIG. 3), wherein first peripheral confinement barrier 122 and second peripheral confinement barrier 126 each comprise walls 140 extending from first floor surface 120 and second floor surface 124 (see FIG. 3) to roof 138, whereby livestock enclosure 100 affords shelter from weather and security to livestock 10 in livestock enclosure 100.

Turning now to FIG. 6, livestock enclosure 100 may comprise a motor 142 configured to rotate adjustable feeder 102 about vertical axis of rotation 132 (FIGS. 1 and 3), and a control 144 enabling a person to rotate adjustable feeder 102 between the first deployed position and the second deployed position. Control 144 may be a two position pushbutton switch, for example, each position corresponding to exposing adjustable feeder 102 to one of first and second housing areas 108, 110.

Where livestock enclosure 100 comprises a closure controlling ingress and egress between first portal 106 and second portal 128 (e.g., any of first and second doors 112, 116, and first and second gates 114, 118), livestock enclosure 100 may also comprise a motor 146 (or motors 146, 148) configured to open and close the closure, and a control 144 (or two controls 144) enabling a person to operate opening and closing of the closure.

Control 144 may comprise a timer, a connection to a programmable controller, or any other device capable of generating control signals to open and close the closure.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A livestock enclosure for housing livestock and selectively evacuating a portion of the livestock enclosure for maintenance thereto, the livestock enclosure comprising:
a first housing area including a first floor surface, a first peripheral confinement barrier surrounding the first floor surface, and a first portal enabling egress from the first housing area through the first peripheral confinement barrier;
a second housing area including a second floor surface, a second peripheral confinement barrier surrounding the second floor surface, and a second portal enabling egress from the second housing area through the second peripheral confinement barrier;
an adjustable feeder selectively movable to a first deployed position wherein feed contained within the adjustable feeder is accessible to livestock in the first housing area and to a second deployed position wherein feed contained within the adjustable feeder is accessible to livestock in the second housing area.

2. The livestock enclosure of claim 1, wherein a portion of the first peripheral confinement barrier is in common with a portion of the second peripheral confinement barrier.

3. The livestock enclosure of claim 1, wherein the adjustable feeder is located in the portion of the first peripheral confinement barrier in common with the portion of the second peripheral barrier.

4. The livestock enclosure of claim 1, wherein
the first portal is separate from and communicates with the second portal, and
the livestock enclosure further comprises a closure selectively opening and closing the first portal to the second portal.

5. The livestock enclosure of claim 1, wherein the first portal and the second portal are unitary, and include a closure selectively opening and closing the first portal and the second portal.

6. The livestock enclosure of claim 1, further comprising a supplementary feeder located such that feed contained within the supplementary feeder is accessible to livestock in at least one of the first housing area and the second housing area.

7. The livestock enclosure of claim 6, wherein
a portion of the first peripheral confinement barrier is in common with a portion of the second peripheral confinement barrier, and
the supplementary feeder is located in the portion of the first peripheral confinement barrier in common with the portion of the second peripheral confinement barrier.

8. The livestock enclosure of claim 1, wherein the adjustable feeder is rotatable about a vertical axis of rotation.

9. The livestock enclosure of claim 8, further comprising a motor configured to rotate the adjustable feeder about the vertical axis of rotation, and a control enabling a person to rotate the adjustable feeder between the first deployed position and the second deployed position.

10. The livestock enclosure of claim 1, further comprising
a closure controlling ingress and egress between the first portal and the second portal; and
a motor configured to open and close the closure, and a control enabling a person to operate opening and closing of the closure.

11. The livestock enclosure of claim 1, further comprising a roof above the first housing area and the second housing area, wherein the first peripheral confinement barrier and the second peripheral confinement barrier each comprise walls extending from the first floor surface and the second floor surface to the roof, whereby the livestock enclosure affords shelter from weather and security to the livestock in the livestock enclosure.
